(19) United States
(12) Patent Application Publication
(10) Pub. No.: US 2009/0079539 A1
(43) Pub. Date: Mar. 26, 2009

(54) JSI Key

(75) Inventor: Linsley A. Johnson, Berkeley, CA (US)

Correspondence Address: LINSEY A. JOHNSON, 2214 CHANNING WAY #8, BERKELEY, CA, 94704, US

(73) Assignee: Linsley A. Johnson, Berkeley, CA (US)

(21) Appl. No.: 11/900,118

(22) Filed: Sep. 10, 2007

Related U.S. Application Data
(60) Provisional application No. 60/843,903, filed on Sep. 12, 2006.

(51) Int. Cl. G08B 29/00; G06K 9/00; G06Q 40/00

(52) U.S. Cl. 340/5.83; 382/124; 705/44

(57) ABSTRACT

The JSI Key and its (CRS) Chip Recognition System, biometric fingerprint technology and integrated applications and functions can reduce and eliminate identity and vehicle theft, fraudulent electronic transactions at a point of sales outlet, and provide biometric entry access with designated driver and (e) print technology for vehicles and provide biometric entry access to a residence or designated facility.

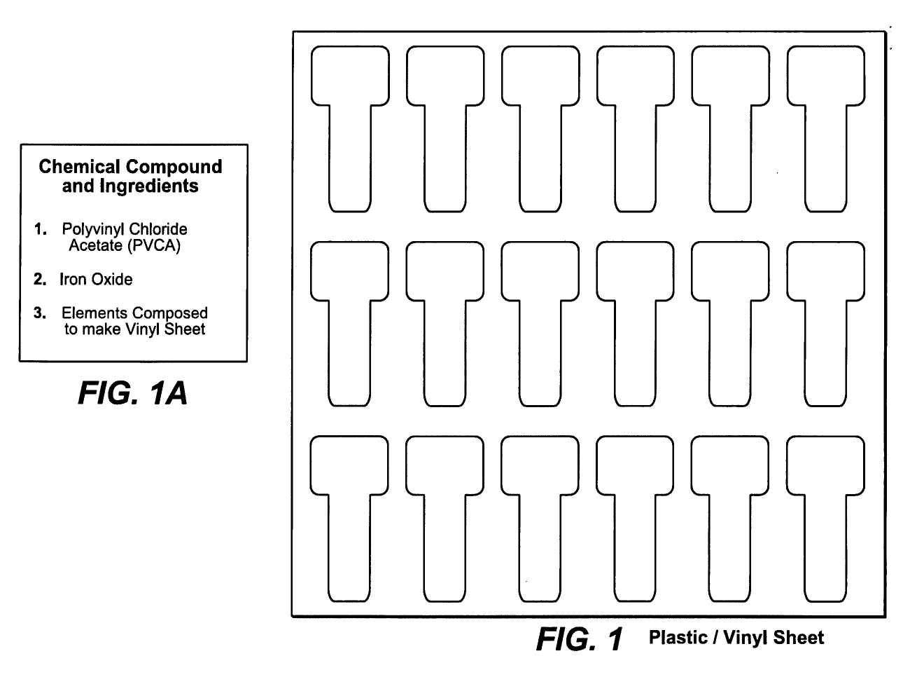

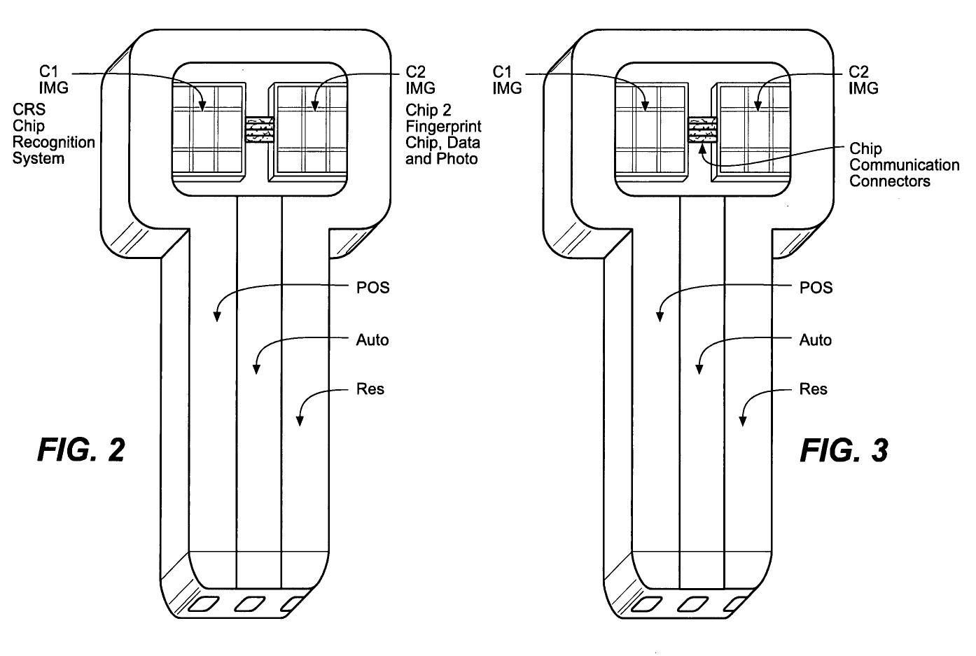

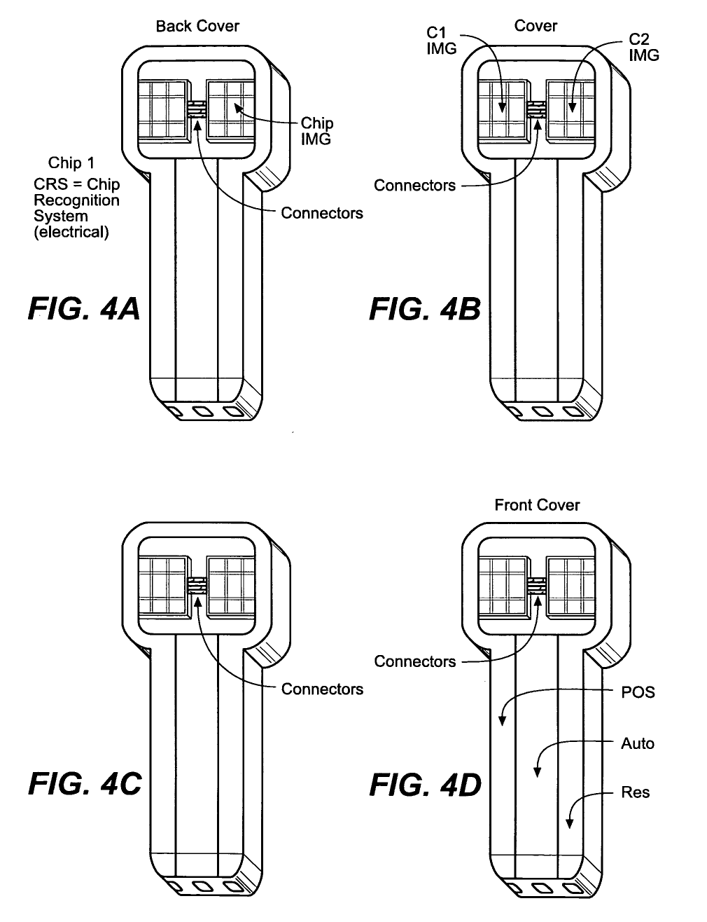

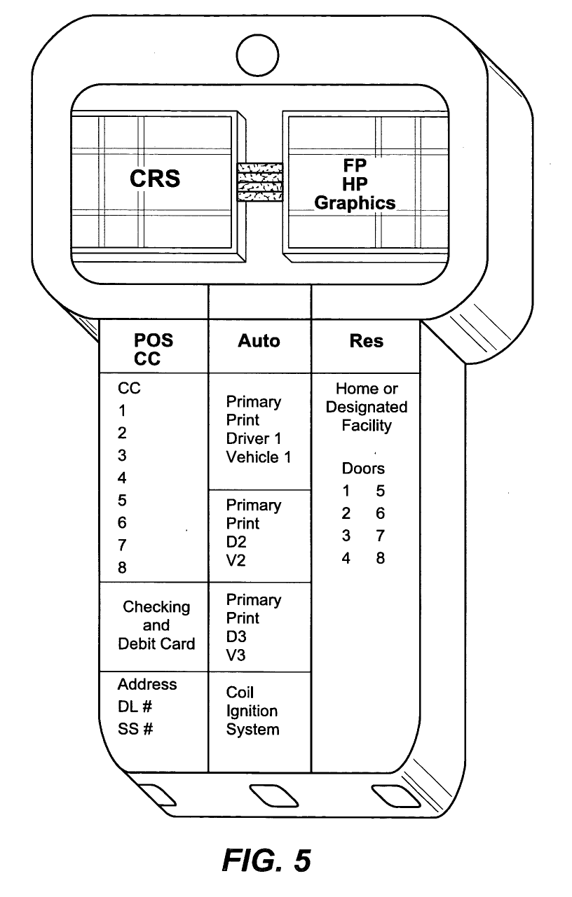

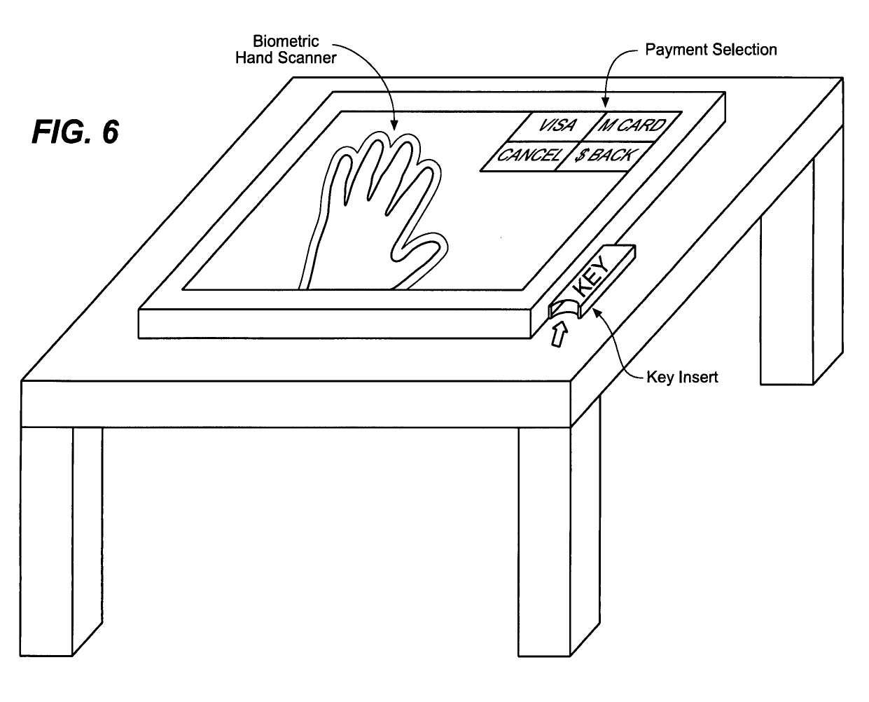

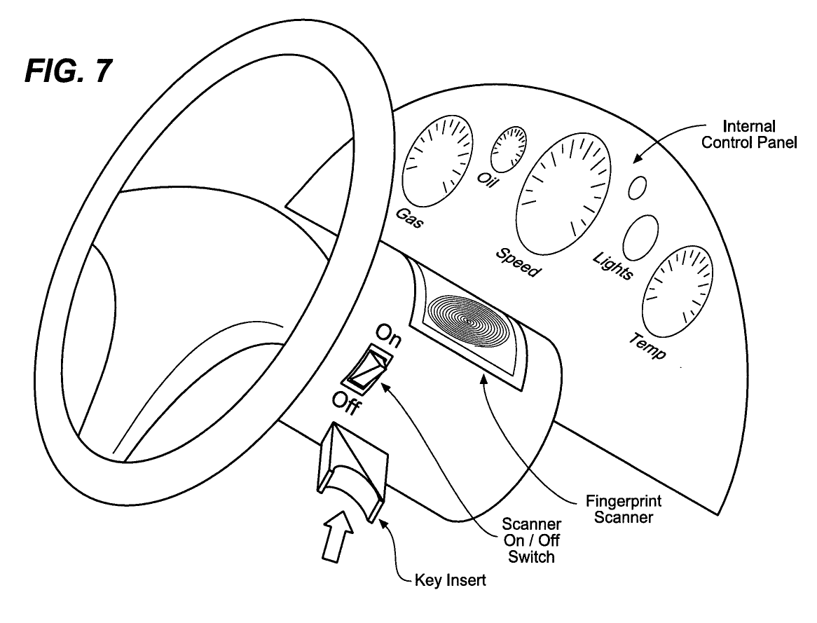

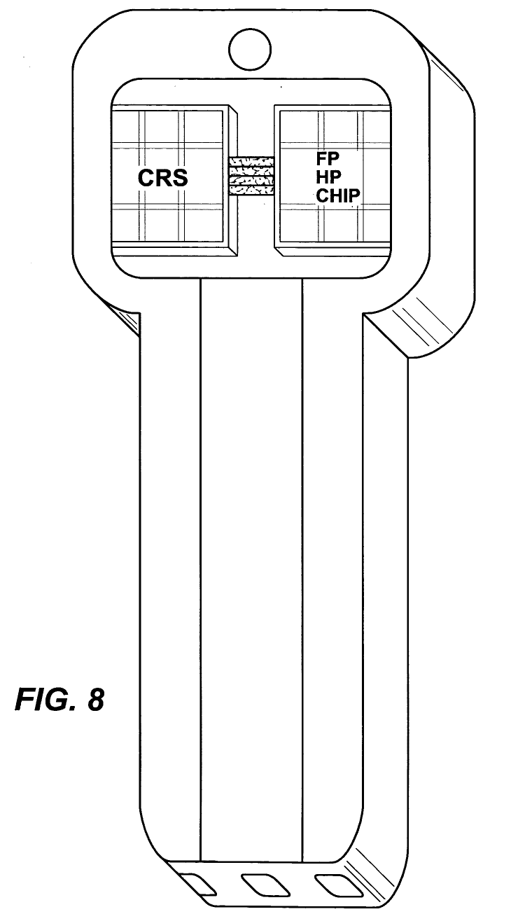

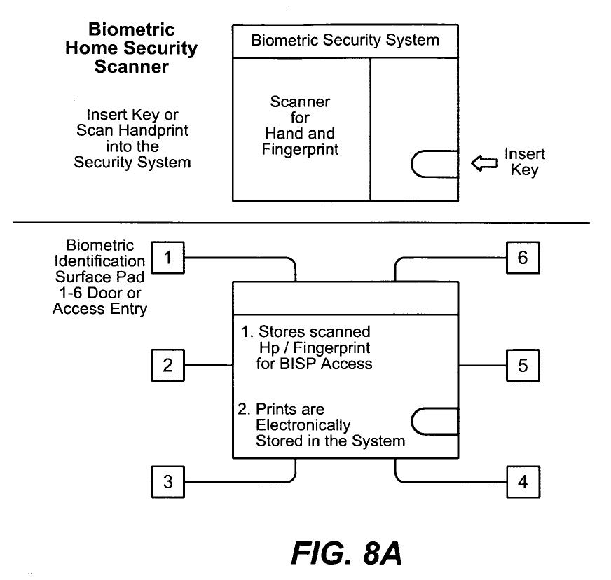

Jstone Industries has developed an integrated product that convergences biometric fingerprint technology and a (CRS) Chip Recognition System that can identify and control three different landscapes that are heavily used by consumers and merchants. The chip recognition system with its electrical sensors can identify a JSI-Point of Sales application, JSI-Automotive application and a JSI-Residential or Designated facility unit and all of their functions within their designated landscapes.

### CROSS REFERENCE TO RELATED APPLICATION

Not applicable to patent request.

### STATEMENT REGARDING FEDERALLY SPONSORED RESEARCH AND DEVELOPMENT

Not applicable to patent request.

### REFERENCE TO SEQUENCE LISTING, A TABLE OR COMPUTER PROGRAM LISTING COMPACT DISC APPENDIX

Not applicable to patent request.

### BACKGROUND OF THE INVENTION

Jstone Industries has spent several years researching consumers, merchants, and the point of sales processes, financial institutions-credit card providers and their fraudulent business activities and their operational processes and procedures. Combining this research with legal, audited, and non-audited documents provided to the Federal Reserve Bank (annual and quarterly reports) The Federal Trade Commission, credit card industry reports on their business activities and market share and consumer business reports on identity theft and business losses.

The research data clearly states that the combined industries lose more than 10 billion dollars a year on identity and vehicle theft, fraudulent point of sales transactions, and administrative and research cost to investigate these thefts. Presently, the point of sales losses are due to one product (the credit card) and the point of sales network, and the function and procedures currently being used by most consumers, merchants, and credit card providers.

After analyzing and evaluating these industries and other business practices, procedures and processes, JSI developed the JSI Key that has a biometric multi-functional ability that will protect the consumers as they migrate from their home to their vehicles and in the merchant-business sector.

JSI has technically audited all the present front-end infrastructures processes and procedures and developed an administrative and technical process to reduce and eliminate identity and vehicle thefts and electronic fraudulent point of sales transactions. Using the present product (the credit card) and the point of sales system, the merchant, or the network positively authenticate the identity of the person using a credit card. Therefore, these fraudulent business transactions are being conducted daily. With this new product (the JSI Key) and its fingerprint biometric technology and the procedures to retain and use a JSI Key no individual can conduct a fraudulent point of sales transaction when a merchant is utilizing a JSI Key point of sales application. The JSI Key can protect the consumers and merchants from identity and vehicle thefts and credit card providers from fraudulent business transactions.

### BRIEF SUMMARY OF INVENTION

JSI has researched and designed a multi-functional biometric product with a chip recognition system that can control and operate three different consumer life sectors. Those sectors are (POS) Point Of Sales, automotive access and driver designation, and residential access or designated facility.

The JSI Key is designed with a biometric fingerprint software program and CRS-Chip Recognition System. The JSI Key can: (1) retain and retrieve personal and financial data and provide authentic biometric identification for a Point of Sales application; (2) provide automotive entry and authorized driver approval; and (3) provide entry access to a home or designated facility.

Jstone Industries, JSI is attempting to deploy the first biometric-based and electromagnetic product in the market that can operate and control three independent infrastructures packaged together to provide an authentic biometric identification for access.

### BRIEF DESCRIPTION OF THE SEVERAL VIEWS OF THE DRAWING

The following drawing illustrates the technical and manufacturing process for the JSI Key and a description of the final product and how the product is used by the consumer and the merchants.

Figures and drawing (1-11) and (3) computer generated drawing.

Also review (007-016) or pages (6-11) for detail production process.

Also section detail description of the invention starting at section (035) and page 26.

### DETAIL DESCRIPTION OF THE INVENTION

The JSI Key is a biometric fingerprint based product with a multi-functional system integration application combined with a Chip Recognition System (CRS) and electrical sensors that can identify and control three different environments and they are the (POS) Point of Sales for merchants that will prevent electronic fraudulent transactions and identity theft, Automotive; provide entry access for designated driver with its (e) print technology, residential or designated facility; that provides entry access to high valued places.
1. In the Point of Sales application JSI Key works in conjunction with the JSI Biometric Payment Center located at most or all point of sales counter top and with the integrated biometric ATM—Automatic Teller Machines that are equipped with JSI biometric fingerprint technology.
2. In the automotive application on top of the steering column is a JSI biometric auto scanner. The vehicle owner will insert their JSI Key into the ignition and turn the scanner on and then place their selected finger on top of the scanner and the print in scanned into the vehicle electrical system and on the JSI Key automotive track as primary driver one. Two additional drivers can be added on to the JSI Key automotive track using (e) print technology. On the outside of the vehicle in the door handle area are visual or non-visual (BISP) Biometric Identification Surface Pad to provide entry to the vehicle. Only the prints install in the vehicle will have access to the vehicle and authorization to drive the vehicle.
3. Residential or designated facility access in the application the JSI Key can be used in commercial or residential markets. With the JSI Biometric Identification Surface Pad (BISP) technology and its biometric network the JSI Key can support up to five (BISP) pads. The designated individual prints are scanned into the JSI access network and the (BISP) pads are electronically connected to the network, therefore, once the prints are scanned into the network the user can enter the designated location with or with out their JSI Key.

Jstone Industries, (JSI) has designed and developed a black electromagnetic integrated biometric key that is one inch in width and three inches long (1×3). The JSI Key is designed with a (0.2) rectangle open space for easy access to carry and accessibility. The following information can be scanned on, stored, and biometrically retrieved from the JSI Key designated finger and hand print, eight credit card numbers and checking and saving account numbers all with debit capability, photo, driver license and number, social security number, home address and telephone number. The JSI Key has two (0.10) electromagnetic plates install on both sides of the key to function in its automotive application. The JSI Key is designed to prevent identify theft and secure high valued assets.

### Size

The JSI Key is 1×3 inches in length with a (0.1 inch) inserted hole for attachment purposes and weighs (3 oz).

### Storage Capacity

The JSI Key has 2 MB of storage for the following usage. (1 MB) for data, which store up to (8) credit card numbers, checking and saving account numbers, with debit capability, drivers licenses information and photo, social security number, and addresses. Next is the (1 MB) chip for graphics, fingerprints and photos. The JSI Key also stores the digital biometric finger prints for the primary and secondary users in all of its applications. (POS-AUTO-RES)

### Three Track Function

Design with electrical sensory for a point of sales applications, automotive and electrical ignitions systems, and residential & designated facility access. The JSI Key provides key holders with an option function to select ALL (3) services, or 2 of the 3, or 1 of the 3 biometric security functions for their protections.

### Performance

The JSI Key has a two chip instructional performance that includes a (CRS) Chip Recognition System to identify infrastructures and provide functions, and biometric fingerprint chip for print storage and verification of identification. The JSI Key has a multi-directional biometric based magnetic reader with storage and retrieval functions combined with two electromagnetic coil ignition metal plates (0.10) in diameter located in the center base of the JSI Key and appearing on both sides internal and external. The CRS chip is silicon based chip with the ability to send and receive electromagnetic sensory signals to identify the infrastructures of point of sales, electrical automotive ignition systems and residential or designated facility access. The CRS chip and the biometric fingerprint chip is (2×2) mm in diameter and the weight is (0.2) oz.

### Physical Material

### Iron Oxide and PVCA—Polyvinyl Chloride Acetate.

One of the core functions of the JSI Key in the point of sales application is prevent identify theft through fraudulent electronic transaction conducted a point of sales outlet, provide authentic biometric identification for identity and security purposes and finally assist merchant in reducing and eliminating their fraud cost. A second feature in the authentication process allows the keyholder's required and optional information to appear on a secure monitor for the customer service agent and keyholder to view.

The Chip Recognition System (CRS) is designed with a two chip system and the (SOC) System on Chip with electrical sensors that can identify, control, and operate three independent infrastructures (POS-AUTO-RES) packaged together and controlled by a biometric fingerprint. The (CRS) system is the core technology that is embedded in the JSI Key and control all the Keys' functions. Once the JSI Key is inserted into one of the three applications the (CRS) quickly identifies that landscaped and requires a biometric match to proceed in that environment. If no biometric match can be provided then no access to either landscape will be granted.

The JSI Key works in a dual function with the JSI Biometric Scanner Payment Center for the (POS) point of sales application and the integrated (ATM) Automatic Teller Machine, in the automotive infrastructure using its (e) print and (BISP) Biometric Identification Surface Pad technology that provider the owner the ability to biometrically designate up three drivers per vehicle and finally in the entry access to designated facility access.

The JSI Key is designed to provide consumers, merchants, and financial institutions an unparallel and premier product that will reduce and eliminate identity theft and electronic fraudulent transactions conducted at a point of sales area and protect the consumer's assets as they migrate from their homes, to their personal vehicles and into the business sectors.

The JSI Key is designed with several complex security features starting with its (CRS) Chip Recognition, fingerprint and handprint technology, and the integrated technology process for supporting products and applications. With all of these security measures and components combines in one product it will begin to shift and managed the way and process to manage and access data and protect personal and professional assets.

The JSI Key is a biometric product designed to prevent identity theft and protect the JSI Key owner personal and financial assets by using their finger or handprint in a biometric application. The JSI Key is a replacement for the physical and plastic credit card but not the transactions conducted with the card. The JSI Key is used in the same process as a credit card or any other high valued magnetic strip card.

The primary function of the JSI Key in the Point Of Sales application is to provide authentic biometric identification and access to the key holders' personal financial information that is located on the JSI Key. The second feature in the authentication process allows the key holder's required and optional information to appear on the monitor for the customer service agent and key holder to view.

The JSI Key is designed to work with the biometric scanner payment system, but can be easily configured to work with IBM, NEC, and NCR registers. Operating within the Point of Sales infrastructure, the following activities are designed to take place:
1. Keyholder inserts their JSI Key into the biometric scanner payment system.
2. Keyholder places their hand or designated finger on top of biometric scanner payment scanner.
3. The handprint or fingerprint is scanned to match handprint or fingerprint stored on the JSI Key.
4. If the scanned handprint or finger print matches the stored handprint or fingerprint then Keyholder financial menu opens along with photo and other designated information.
5. Keyholder selects a form of payment or split payment among the financial applications stored on the JSI Key and get cash back.
6. Transaction is completed, receipt generated for Keyholder.
   If the scanned handprint or fingerprint does not a match the handprint or fingerprint stored on the JSI Key no financial information will be provided at the point of sales and the transaction can not be conducted.

The HP/FP match process is required and verified in all of the JSI Key applications point of sales, automotive, residential or designated facility. If the scanned prints in the designated system do not match the prints on the JSI Key no access will be provided.

### DRAWING

### When Necessary

There are (11) drawings/figures to illustrate the multiple functions of the JSI Key and three computer generated drawings in this application.

Drawing (1-11) illustrates the manner and process of making from the chemical compounds to the final products and the three computer generated drawing reflect the product and the different consumer and business environments that it can provide access to and manage their designated processes.

### SPECIFICATION

### Written Description

The JSI Key is a biometric fingerprint based product with a multi-functional system integration application combined with a Chip Recognition System (CRS) and electrical sensors that can identify and control three different environments and they are the (POS) Point of Sales for merchants that will prevent electronic fraudulent transactions and identity theft, Automotive; provide entry access for designated driver with its (e) print technology, Residential or designated facility; provide entry access to high valued places.
1. In the Point of Sales application JSI Key works in conjunction with the JSI Biometric Payment Center located at most or all point of sales counter top and with the integrated biometric ATM—Automatic Teller Machines that are equipped with JSI biometric fingerprint technology.
2. In the automotive application: On top of the steering column is a JSI biometric auto scanner. The vehicle owner will insert their JSI Key into the ignition and turn the scanner on and then place their selected finger on top of the scanner and the print is scanned into the vehicle electrical system and on the JSI Key automotive track as primary driver one. Two additional drivers can be added on to the JSI Key automotive track using (e) print technology. on the outside of the vehicle in the door handle area are visual or non-visual (BISP) Biometric Identification Surface Pad to provide entry to the vehicle. Only the prints install in the vehicle will have access to the vehicle and authorization to drive the vehicle.
3. Residential or designated facility access in the application the JSI Key can be used in commercial or residential markets. With the JSI Biometric Identification Surface Pad (BISP) technology and its biometric network the JSI Key can support up to five (BISP) pads. The designated individual prints are scanned into the JSI access network and the (BISP) pads are electronically connected to the network, therefore, once the prints are scanned into the network the users can enter the designated location with or with out their JSI Key.

Jstone Industries, (JSI) has designed and developed a black electromagnetic integrated biometric key that is one inch in width and three inches long (1×3). The JSI Key is designed with a (0.2) rectangle open space for easy access to carry and accessibility. The following information can be scanned on, stored, and biometrically retrieved from the JSI Key; designated finger and hand print, eight credit card numbers and checking and saving account numbers all with debit capability, photo, driver license and number, social security number, home address and telephone number. The JSI Key has two (0.10) electromagnetic plates install on both sides of the key to function in its automotive application. The JSI Key is designed to prevent identify theft and secure high valued assets.

The primary function of the JSI Key in the point of sales application is prevent identify theft through fraudulent electronic transaction conducted a point of sales outlet, provide authentic biometric identification for identity and security purposes and finally assist merchant in reducing and eliminating their fraud cost. A second feature in the authentication process allows the keyholder's required and optional information to appear on a secure monitor for the customer service agent and keyholder to view.

The Chip Recognition System (CRS) is designed with a two chip system and the (SOC) System on Chip with electrical sensors that can identify, control, and operate three independent infrastructures packaged together and controlled by a biometric fingerprint. The (CRS) system is the core technology that is embedded in the JSI Key and controls all the Keys' functions. Once the JSI Key is inserted into one of the three applications the (CRS) quickly identifies that landscaped and requires a biometric match to proceed in that environment. If no biometric match can be provided then no access to either landscape will be granted.

The JSI Key is designed to provide consumers, merchants, and financial institutions an unparallel and premier product that will reduce and eliminate identity theft and electronic fraudulent transactions conducted at a point of sales area and protect the consumer's assets as they migrate from their homes, to their personal vehicles and into the business sectors.

The JSI Key is designed with several complex security features starting with its (CRS) Chip Recognition, fingerprint and handprint technology, and the integrated technology process for supporting products and applications. With all these security measures and components combines in one product it will begin to shift and managed the process to manage and access data and protect personal and professional assets.

### The Manner and Process of Making

The JSI Key is made of a high density and durable plastic that is made from melting and mixing polyvinyl acetate, iron oxide and other addictives. The blended compounds are transformed in several core sheets that are (10×10) and then passed into a molding unit, which guides the plastic sheets through a small flat black die setting.

As the sheets enter and exist the die they are propelled through a series of mechanical rollers that pull the sheets along. The rollers keep the sheets flat and maintain their proper thickness of ( 1/10) of an inch. The sheets are then passed through a cooling unit before being cut into separate and multiple product parts to form the JSI Key. The dimensions for the JSI Key are three inches in length and one inch wide and these cuts are made from the sheets by electrical automated shears or hot wires. The JSI Key has a (0.2) rectangle open space cut into the front and the back parts of the key for easy accessibly. As the sheets are rolled through the production process the JSI Key design and shape is printed over the sheets and punched in the production process.

After the JSI Key shape and design is punched out from the polyvinyl sheets both parts front and back are sprayed with iron-oxide that which will give the JSI Key the ability to encode binary data. Afterwards, a set of rollers will positioned both parts of the key in a open face position and they are individually layered and prepared for next stage in the manufacturing process, which consist of install internal parts.

The next set of mechanical rollers will pull the layered sheets of plastic open face parts (two) pieces at this point and position them for their internal parts to be installed, which consist of two silicon based chips. With both parts being positioned in an open face position a (0.2) divisional border in placed in the three inch vertical section of the JSI Key, thus creating three tracks in the key. Once the divisional border is in place a mechanical arm then place (chip one) the biometric finger print chip is installed. This chip has the ability identify the designated users by storing their prints. This chip is place on the left hand side of the (1) inch square section of the JSI Key.

Another mechanical arm will position (chip two), the Chip Recognition System that has the electrical sensors to identify the designated landscapes, point of sales, automotives, and residential or designated facility access on the right side next to chip one and their lines communications are then connected. The next step is to connect the (CRS) Chip Recognition System and its' electrical sensors to the divisional borders, therefore the (CRS) can activate each sector of the JSI Key after getting a biometric approval.

After both chips are installed a third mechanical arm will install two dual embedded electromagnetic metal coil ignition plates (0.10) ( 1/10) of an inch in length on both sides of the bottom area of the three inch vertical section of the JSI Key with the coil plates being visible from the exterior.

The next set of electrical rollers and mechanical arms will gradually move the JSI Key into the final stage of the production process. At this point the JSI Key is in two parts with the two chips installed, divisional border installed and they are positioned on the back sides and the following and final activities are scheduled to take place.

The final stage of the production process takes place at the production tracking station which consist of (1) Inserting the security ink pack to deter and prevent physically unauthorized opening of the JSI Key, (2) Engraving the laser digital numeric code that identifies a JSI Key by production batch and names series, geographical location and other internal security data, (3) Permanently sealing all the parts together and final lamination, and finally (4) damage testing under normal and reasonable conditions.

In the final stage of the production process the JSI Key is fed through a system of rollers. Rolls of laminated stock are placed on both sides of the key and then the mechanical rollers push the JSI Key into a vacuum shoe that holds both parts of the key together while it is move into a tracking station. As the mechanical rollers move the JSI Key into the tracking station a small ink packed is positioned internally completely around the JSI Key. This pack will explode if any part of the JSI Key is electronically, mechanically or by human force separated after the JSI Key has completed the production process and distributed to consumers and business partners.

After the ink pack is installed the JSI Key has a laser digital numeric code electrically scanned into the JSI Key with special coding to identify the key's production name batch and internal security information.

The next step is to seal all the part of the JSI Key together. The sealing of the key is done by a pair of quartz infrared heated lamps that warm the left and the right side of the plastic film on the JSI Key. The lamps are backed with reflectors to focus the radiant energy on a narrow area of the films, which optimizes a smooth bonding of the film on the JSI Key. The final lamination step protects the finish JSI Key and increases it strength. The laminated films on both sides of the JSI Key are fully bonded to the JSI Key by pressing with metal platens, which are heated to (266) Fahrenheit or 130 Celsius with a pressure of (166 psi/per square inch). This process can take up to three minutes.

The final component in the production process for the JSI Key is the quality assurance (Q/A). This process consist of uploading a series of data templates and conducting several transaction test performance using the JSI Biometric Payment Center, several standard automotive ignition applications and the residential or designate facility access unit. These tests are required to evaluate the JSI Key final approval and internal systems performance. The next step in production process is to test for consumer durability under normal product functional procedures and daily usage and care before sending the final product to financial institutions and business partners.

### Using the Same: The Process: Internal and External

The data conversion process from the credit card to the JSI Key.

### Internal:

The JSI Key is a biometric product designed to prevent identity theft and protect the JSI Key owner personal and financial assets by using their finger or handprint in a biometric application. The JSI Key is a replacement for the physical and plastic credit card but not the transactions conducted with the card. The JSI Key is used in the same process as a credit card or any other high valued magnetic strip card.

The primary function of the JSI Key in the Point Of Sales application is to provide authentic biometric identification and access to the key holders' personal financial information that is located on the JSI Key. The second feature in the authentication process allows the key holder's required and optional information to appear on the monitor for the customer service agent and key holder to view. The JSI Key is designed to work with the biometric scanner payment system, but can be easily configured to work with IBM, NEC, and NCR registers. Operating within the Point of Sales infrastructure, the following activities are designed to take place:
1. Keyholder inserts their JSI Key into the biometric scanner payment system.
2. Keyholder places their hand or designated finger on top of biometric scanner payment scanner.
3. The handprint or fingerprint is scanned to match the handprint or fingerprint stored on the JSI Key.
4. If the scanned handprint or finger print matches the stored handprint or fingerprint then Keyholder financial menu opens along with photo and other designated information.
5. Keyholder selects a form of payment or split payment among the financial applications stored on the JSI Key and get cash back.
6. Transaction is completed, receipt generated for Keyholder.
   If the scanned handprint or fingerprint does not a match the handprint or fingerprint stored on the JSI Key no financial information will be provided at the point of sales and the transaction can not be conducted.

The HP/FP match process is required and verified in all the JSI Key applications, point of sales, automotive, residential or designated facility. If the scanned prints in the designated system do not match the prints on the JSI Key no access will be provided.

This initial process starts with the credit card providers and the automated clearing houses entering a subscription membership with JSI and authorize JSI to read and convert the data from their cardholders' cards and transfer that data onto a JSI Key. The cardholder will come into a membership affiliated bank or JSI designated facility and fill out a JSI Key application. Afterward JSI will research and verify the data through seven multiple approved verifiable sources to confirm the cardholders identify. If all the sources approve the cardholders' identify they will be notified to come back to the bank or designated facility with their credit card and JSI will transfer the credit card data to the JSI Key.

At this point JSI will take a digitalize set of fingerprints and retain a physical-electronic signature and transfer that data/images on the JSI Key Therefore, when the consumer makes a purchase there is (NO) need for a pin number or signature. The JSI Key provides a captured and retained signature and validated identify. This process is a electronic version of having a customer signature on a bank card, instead of faxing a copy of the card to a designated institution the electronic signatures goes with the customer and is validated by their fingerprints.

This process will also begin to eliminate the need to multiple networks for credit cards, debit cards and signatures as part of the POS-Electronic Payment infrastructure for credit card and merchant card providers, thus reducing additional operational and administrative cost. If the stored fingerprint (s) on the JSI Key match the scanned fingerprint at Point of sales then all the data is validated and verified, (NO) pin number or signature is required and no fraudulent transactions can be authorize.

After all the transactions have been confirmed and validated, JSI will provide the customer with a monthly consolidated billing statement. This process and technology reduces all credit card provider and merchants billing and administrative cost. The customer will get (1) bill that reflects all the transactions conducted with their JSI Key and then be required to send in the designated payment and JSI will disperse the funds to the appropriate merchants on the customers JSI Key. JSI will review and take under consideration licensing its technology for the JSI Consolidated Billing Platform out to First Data or an Automated Clearing House.

If the cardholder is not approved or can not be verified by all of JSI sources the cardholders' issuing bank or provider will be notified of the fraudulent identity issues, and then with the issuing banks permission the cardholder will be notified. This process is estimated to take 5 to 10 business days for completion.

Finally, the JSI Key holder can select to use all the JSI Key functions or they can select which functions they want the JSI Key to perform the Point of Sales Activity, Automotive Access and Designated Driver, Residential and Facility Access. Each of these consumer related business landscapes have two or more supporting products with multiple features.

### External:

JSI will sale the JSI Biometric Payment System to all merchants that excepts credit and debit cards, thus replacing the current card readers on the merchants countertops. Afterward the consumer can take their JSI Key out in the market place and use it any Point of Sales area that has a JSI Biometric Payment System. This process will start to reduce and eliminate fraudulent transactions and identify theft conducted with credit and debit cards at a Point of Sales outlet.

From a point of sales outlet the Biometric Payment System transmissions can be ran over the current credit and debit card networks, thus eventually eliminating the multiple card networks and migrating everything over to a biometric network. With the biometric network (NO) pin number or signature would be required because you already have a captured electronic signature and biometric match.

The JSI Key is a biometric fingerprint based product with a multi-functional system integration application combined with a Chip Recognition System (CRS) and electrical sensors that can identify and control three different environments and they are the (POS) Point of Sales for merchants that will prevent electronic fraudulent transactions and identity theft, Automotive; provide entry access for designated drivers with its (e) print technology, residential or designated facility that provides entry access to high valued places.

1. The JSI Key is designed to work with the biometric scanner payment system, but can be easily configured to work with IBM, NEC, NCR and other registers. Operating within the Point of Sales infrastructure, the following activities are designed to take place:
1. Keyholder inserts their JSI Key into the biometric scanner payment system.
2. Keyholder places their hand or designated finger on top of biometric scanner payment scanner.
3. The handprint or fingerprint is scanned to match handprint or fingerprint stored on the JSI Key.
4. If the scanned handprint or finger print matches the stored handprint or fingerprint then Keyholder financial menu opens along with photo and other designated information.
5. Keyholder selects a form of payment or split payment among the financial applications stored on the JSI Key and get cash back.
6. Transaction is completed, receipt generated for Keyholder.
If the scanned handprint or fingerprint does not a match the handprint or fingerprint stored on the JSI Key no financial information will be provided at the point of sales and the transaction can not be conducted.

2. In the automotive application the JSI Key can identify the designated drivers by their fingerprints that are scanned into the vehicles' electrical system by the owner and the prints are designated as (e) prints. The prints are installed in vehicle's electrical system with a small JSI automotive scanner that is embedded in the center of the steering column in any automotive application.
The JSI Key can identify up to three drivers per vehicles and give them access and control of the vehicle. The JSI Key works in conjunction with the Biometric Identification Surface Pads (BISP) Technology that will secure the owner's vehicle and provide the owner with a designated driver function to eliminate auto theft. JSI has developed a (1×3) electromagnetic key with a dual embedded electromagnetic metal coil ignition plated (0.10) ( 1/10) of an inch in length on both sides of the bottom of the JSI Key.
The JSI Key can provide automotive and designated driver access and the JSI Key the owner can designate up to (2) drivers per vehicle that he/she owns. In this application (BISP) Biometric Identification Surface Pads are stored electronically in the car, and the designated user can access the car from the exterior door area or from two non-disclosed or disclosed Biometric Identification Surface Pads (BISP).
After entering the car, the JSI Key, working in conjunction with the ignition system, will let an authorized driver operate the car. Integrated into the top surface area of the steering column is a biometric scanner with the dimension of (1×1) inch and (0.50) inch in depth and has a memory of 2 MB for the designated owner to scan their print or designated prints into the electrical system and on the JSI Key automotive track. In the automotive track the JSI Key and the CRS-Chip Recognition System with its sensors can electronically and automatically identify designated vehicles by the ignition electrical current signals because each vehicle has a different automotive signal. Just as two identical cars have different keys for their ignition system.
In the automotive track when the JSI Key is used for the first time the JSI Key will automatically default to Auto Track (1) where the owner's (e) fingerprint (s) are stored in the electrical system to provide access and control for that car and the print (s) will be displayed in the vehicle control panel. From an operational and functional standpoint the (e) prints stored in the electrical system must always match the (e) prints stored on the JSI Key that is inserted into the ignition, if the prints do not match the vehicle will not start.
This is a dual function: when (e) fingerprint(s) are deleted from the vehicle's electrical system it requires the JSI key therefore, both prints(s) are deleted from the vehicle automotive track and the JSI Key at the same time. The primary owner's print will be in stored in the ignition's electrical system and on all three segments tracks of the automotive track with room to add one driver per segment. In each segment the JSI Key will have the primary drive plus one. This process prevents external thefts because if you are not the primary driver in all three vehicle segments your JSI Key will not work for that vehicle.
Auto Track (2), if the JSI Key owner has a second vehicle equipped with the JSI automotive application, once the key is inserted into the owner second car, the JSI Key will automatically default to Auto Track (2) and designated finger print (s) can be install in the vehicle electrical system for complete access and control.
Finally, if the owner has a third vehicle, when the JSI Key is inserted into that vehicle and if the vehicle is equipped with a JSI Key system it will automatically default to Auto Track (3) and the designated driver fingerprint (s) can be install in the vehicle electrical system. As a dual component the BIPS (Biometric Identification Surface Pads) and the JSI Key applications, working together, will protect the Keyholder vehicle (s) from auto theft. This theft application can be turned on and off with a preset timer controlled by the clock. This feature was designed for short-term authorized drivers, such as valet parking attendants, auto mechanics or designated person.

3. The JSI Key home unit can deter and prevent non-designated individual from entering the JSI Key owner's residence or designated facility. The JSI Key working in conjunction with it (BISP) Biometric Identification Surface Pads can allow the JSI Key owner and designated individual to have access into the residence or designated facility with or without a JSI Key after their prints have been installed in the JSI residential/facility unit.
The homeowner can use the JSI Key to activate the biometric controlled system from inside the house, where the fingerprints and handprints are electrically stored in the door security network. The security network consist of a 5″×11″ biometric scanning panel, image storing kit, and an entry access unit located at all the external entrances to the house using BISP technology. The homeowner can use the JSI Key to scan and store residential members' handprints or fingerprints in the biometric controlled entry access unit.
The biometric controlled entry access unit can support up to five BISPS. An undisclosed or disclosed BISP can be located outside the home or facility. Afterward, the designated individual would place a handprint or fingerprint on the pad to gain access to the home. With this network deployed in the home, designated residence members can enter the home without a key. The biometric application in the home functions as an additional security.
